(19) United States
(12) Patent Application Publication
(10) Pub. No.: US 2026/0062957 A1
(43) Pub. Date: Mar. 5, 2026

(54) FIXING DEVICE

(71) Applicant: SINOX CO., LTD., New Taipei City (TW)

(72) Inventor: Jia-Ci WU, New Taipei City (TW)

(73) Assignee: SINOX CO., LTD., New Taipei City (TW)

(21) Appl. No.: 19/035,210

(22) Filed: Jan. 23, 2025

(30) Foreign Application Priority Data
Aug. 30, 2024 (TW) 113209426

(51) Int. Cl. E05B 37/02; E05B 63/00; E05B 73/00

(52) U.S. Cl. CPC E05B 37/025; E05B 63/0056; E05B 73/00

(57) ABSTRACT

The present utility model provides a fixing device, including a body, a cord, a drive device, and a locking module. The body includes a connection portion, a through portion, and a locating portion. The cord includes a connection end and a locating end, the connection end is fixed to the connection portion, and the locating end can pass through the through portion and is detachably connected to the locating portion. The drive device is disposed in the body, is partially exposed from the body, and movably releases a restriction on a movement direction of the cord and a restriction on the locating end detaching from the locating portion. The locking module is disposed in the body and is partially exposed from the body to restrict movement of the drive device.

### TECHNICAL FIELD

The present utility model relates to a fixing device, and in particular, to a fixing device with a locking function.

### BACKGROUND

Regarding a lock, the U.S. Pat. No. 7,712,339 discloses a lock that mainly includes a lock body and a joint bar hoop connected by a plurality of rod bodies. During use of the lock, the joint bar hoop may be folded as required.

Compared with a traditional U-shaped lock that has a disadvantage that a U-shaped rod cannot deform, the foregoing lock has better use flexibility. However, since a size of the lock cannot be adjusted according to a size of an object to be fixed/locked, and a folding direction of the joint bar hoop is fixed, there is still room for improvement in terms of use convenience.

### SUMMARY

An objective of the present utility model is to provide a fixing device with better convenience of use, to resolve the foregoing problem in the prior art.

The fixing device in the present utility model includes a body, a cord, a drive device, and a locking module. The body includes a connection portion, a through portion, and a locating portion. The cord includes a connection end and a locating end, the connection end is fixed to the connection portion, and the locating end is capable of passing through the through portion and is detachably connected to the locating portion, so that the cord and the body form two limiting areas. The drive device is disposed in the body, and movably releases a restriction on movement of the cord in the through portion and a restriction on the cord detaching from the locating portion. The locking module is disposed in the body, and is capable of restricting movement of the drive device.

In an embodiment of the present utility model, the fixing device further includes a first interference member and a second interference member. The first interference member is disposed in the body, where at least a part is movable into the through portion, and is capable of restricting the cord located in the through portion to moving toward a first direction. The second interference member is disposed in the body, and is capable of restricting the locating end connected to the locating portion to detaching from the locating portion. When the drive device moves to a releasing location, the drive device is capable of abutting against the first interference member and the second interference member separately, to release a restriction of the first interference member on movement of the cord, and a restriction of the second interference member on the locating end detaching from the locating portion.

In an embodiment of the present utility model, the locking module abuts against the second interference member, and when the locking module is in a locked state, the locking module restricts movement of the second interference member.

In an embodiment of the present utility model, the drive device abuts against the second interference member, and when the locking module is in the locked state, the locking module restricts the drive device to moving to the releasing location.

In an embodiment of the present utility model, the first interference member is a rotating member, and the fixing device further includes a first elastic member that provides elastic force to the first interference member, so that the first interference member rotates, until one end extends into the through portion to be clamped to the cord located in the through portion, restricting the cord to moving toward the first direction.

In an embodiment of the present utility model, when the drive device moves to the releasing location, and the drive device is capable of abutting against the first interference member, to overcome the elastic force, so that the first interference member rotates, until the end leaves the through portion, to release the restriction of the first interference member on movement of the cord.

In an embodiment of the present utility model, the locating portion is a groove body, and the fixing device further includes a second elastic member that provides elastic force to the second interference member, so that the second interference member can move to an opening of the groove body.

In an embodiment of the present utility model, when the locating end is subject to external force stronger than the elastic force to pass from the outside of the groove body through an opening of the groove body to enter the groove body, the locating end is capable of pushing the second interference member away from the opening of the groove body, and when the locating end enters the groove body, the second interference member is capable of moving to the opening of the groove body to restrict the locating end to detachment.

In an embodiment of the present utility model, an opening at one end of the through portion and the connection portion are disposed at a top portion of the body, an opening at the other end of the through portion is disposed at a bottom portion of the body, the locating portion is disposed on a side of the body, a through groove is disposed at a bottom portion of the groove body, the locating end has a bump with a diameter greater than a diameter of the cord, when the locating end enters the groove body, the bump is capable of being clamped in the groove body, and the cord is capable of extending out of the body through the through groove.

In an embodiment of the present utility model, an opening at one end of the through portion and the connection portion are disposed at a top portion of the body, an opening at the other end of the through portion is disposed at a bottom portion of the body, the locating portion is disposed on an inner side of the bottom portion of the body, an opening of the groove body is located at a location other than the opening at the other end of the through portion, a through groove in communication with the opening of the groove body is disposed at a bottom portion of the groove body, the locating end has a bump with a diameter greater than a diameter of the cord, when the locating end enters the groove body, the bump is capable of being clamped in the groove body, and the cord is capable of extending out of the body through the through groove.

In an embodiment of the present utility model, the locking module is a combination lock body having a shaft, and the shaft is connected to the second interference member.

### BRIEF DESCRIPTION OF THE DRAWINGS

FIG. 1 is a schematic diagram of an embodiment of a fixing device according to the present utility model;

FIG. 2A and FIG. 2B are exploded schematic diagrams of embodiments of a fixing device according to the present utility model;

FIG. 3A to FIG. 4 are schematic actuation diagrams of embodiments of a fixing device locking and fixing an object according to the present utility model;

FIG. 5A to FIG. 5D are schematic actuation diagrams of embodiments of a fixing device releasing locking and fixing an object according to the present utility model;

FIG. 6A and FIG. 6B are schematic diagrams of different embodiments of a fixing device according to the present utility model; and

FIG. 7A to FIG. 8D are schematic actuation diagrams of different embodiments of a fixing device according to the present utility model.

### DETAILED DESCRIPTION

An implementation of a connection assembly disclosed in the present invention is described below through specific embodiments and accompanying drawings. Those skilled in the art can understand the advantages and effects of the present invention from the content disclosed in this specification. However, the following disclosed content is not intended to limit the protection scope of the present invention. Without departing from the spirit of the present invention, those skilled in the art can implement the present invention by using other different embodiments based on different viewpoints and applications. In the accompanying drawings, the thicknesses of layers, films, panels, areas, and the like are exaggerated for clarity. Throughout this specification, same reference signs represent same elements. It is understood that when an element such as a layer, film, area, or substrate is referred to as being “on” or “connected to” another element, it may be directly on or connected to the other element, or an intermediate element may also exist. In contrast, when an element is referred to as being “directly on” or “directly connected to” another element, no intermediate element exists. As used herein, “being connected” may refer to a physical connection and/or an electrical connection. Furthermore, “an electrical connection” or “being coupling” may mean that another component exists between two components.

It should be understood that, although the terms “first”, “second”, “third”, and the like may be used herein to describe various elements, components, areas, layers, and/or parts, the elements, components, areas, and/or parts shall not be limited by these terms. These terms are merely used to distinguish one element, component, area, layer, or part from another element, component, area, or part. Therefore, a “first element”, “component”, “area”, “layer”, or “part” discussed below may be termed a second element, component, area, layer, or part without departing from the teachings herein.

Additionally, as shown in a figure, relative terms, such as “lower” or “bottom” and “upper” or “top” may be used herein to describe a relationship between one element and another element. It should be understood that relative terms are intended to include different orientations of the apparatus in addition to the orientation shown in the figure. For example, if the apparatus in one of the figures is turned over, an element described as being “below” another element would then be oriented “above” the another element. Therefore, the exemplary term “lower” may include both “lower” and “upper” orientations, depending on a particular orientation of the accompanying drawings. Similarly, if the apparatus in one of the figures is turned over, an element described as “below” or “beneath” another element would then be oriented “above” the another element. Therefore, the exemplary terms “below” or “lower” may include both upper and lower orientations.

As used herein, “about”, “approximately”, or “substantially” includes a stated value and an average value within an acceptable deviation range of a particular value as determined by those of ordinary skill in the art, in consideration of discussed measurement and a specific quantity (that is, a restriction on a measurement system) of errors associated with the measurement. For example, being “about” may mean being within one or more standard deviations of the stated value, or being within ±30%, ±20%, ±10%, or ±5%. Furthermore, as used herein, the term “about”, “approximately”, or “substantially” may select a relatively acceptable deviation range or standard deviation based on an optical property, an etching property, or another property, and one standard deviation may not apply to all properties.

The present utility model provides a fixing device, to fix objects with different sizes. A structure and an operation of the present utility model are explained in detail below with reference to the accompanying drawings.

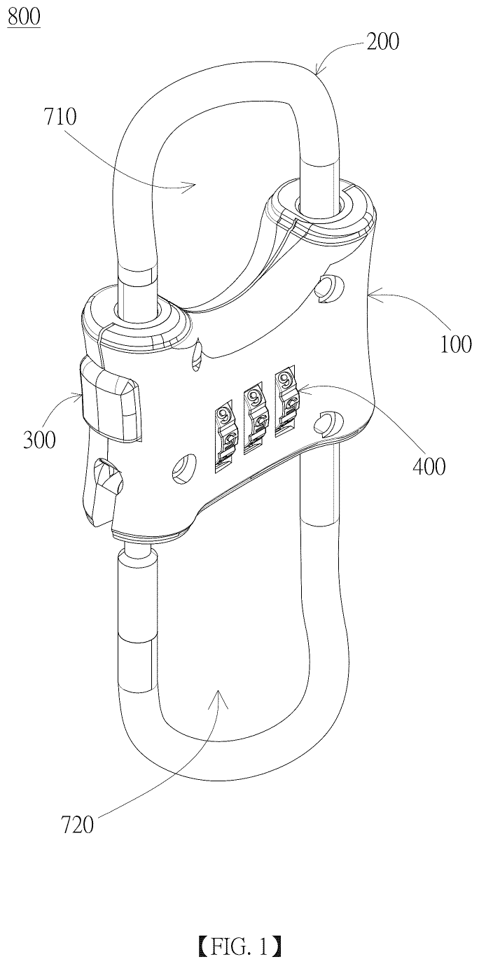

In an embodiment shown in FIG. 1, a fixing device 800 of the present utility model includes a body 100, a cord 200, a drive device 300, and a locking module 400. One end of the cord 200 is fixed to the body 100, and the other end is capable of passing through the body 100 and is connected to another side of the body 100, to form a first limiting area 710 and a second limiting area 720 on both sides of the body 100 respectively. The cord 200 is preferably but not limited to a steel cord.

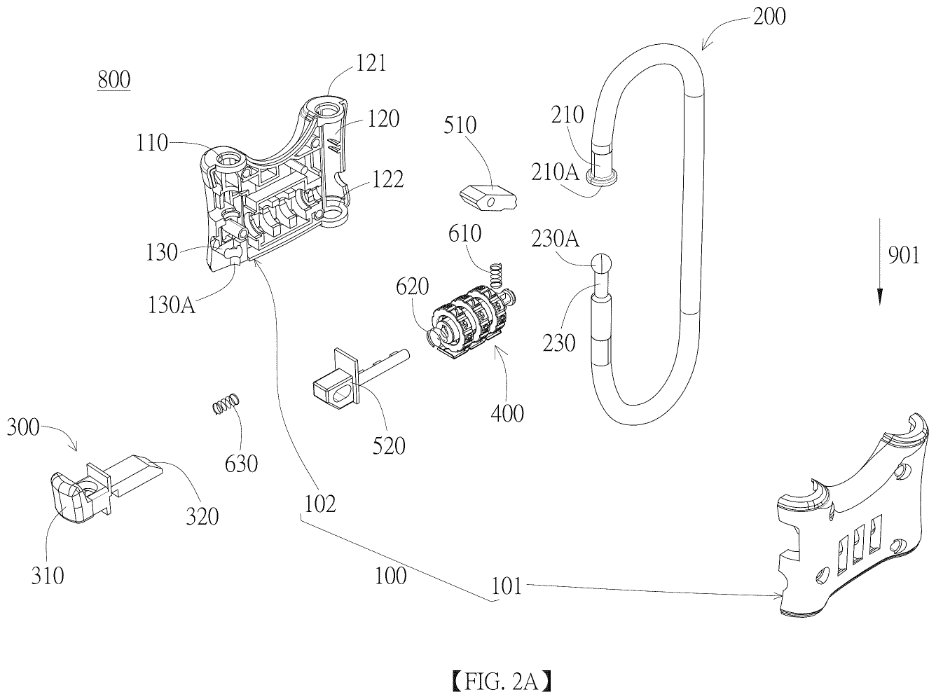

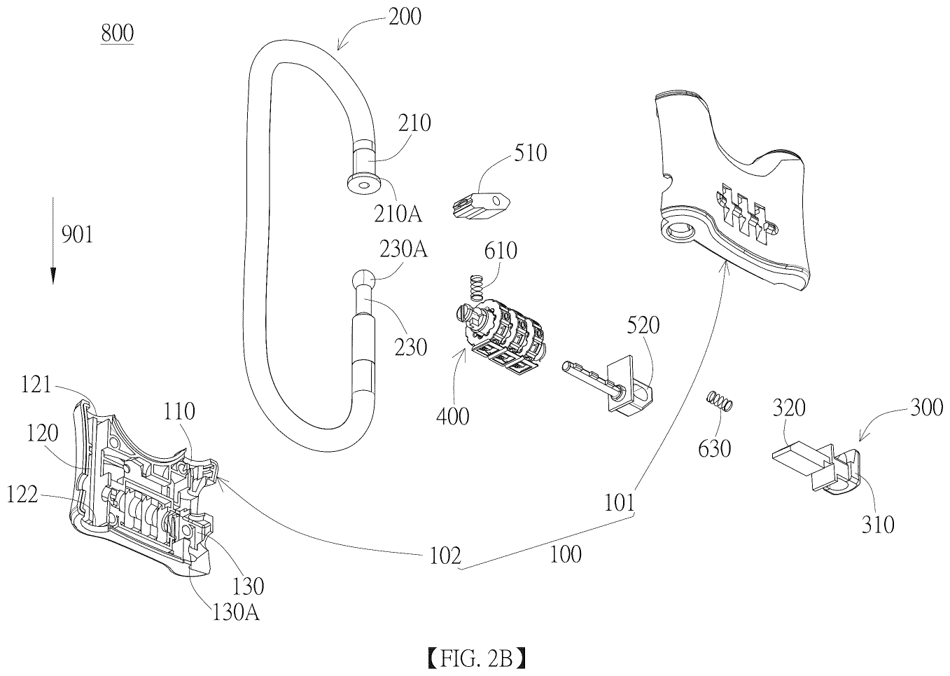

More specifically, in embodiments shown in FIG. 2A and FIG. 2B, for example, the body 100 may be assembled by a front housing 101 and a rear housing 102, and include a connection portion 110, a through portion 120, and a locating portion 130. The cord 200 includes a connection end 210 and a locating end 230, the connection end 210 is fixed to the connection portion 110, and the locating end 230 can pass through the through portion 120 and is detachably connected to the locating portion 130, so that the cord 200 and the body 100 form, for example, two limiting areas that are the first limiting area 710 and the second limiting area 720. In an embodiment, the connection end 210 has an annular flange 210A, and the connection portion 110 is a hole that is provided in an outer housing of the body 100 and whose diameter is less than an outer diameter of the annular flange 210A. Therefore, the cord 200 can pass through the hole to serve as the annular flange 210A of the connection end 210, and is movably limited on an inner side of the outer housing of the body 100. The through portion 120 communicates with the both sides of the body 100. In an embodiment, an opening 121 at one end of the through portion 120 and the connection portion 110 are disposed at a top portion of the body 100, and an opening 122 at the other end of the through portion 120 is disposed at a bottom portion of the body 100.

In an embodiment, the locating portion 130 is disposed on a side of the body 100. The locating portion 130 is a groove body. A through groove 130A is provided at a bottom portion of the groove body. The locating end 230 has a bump 230A whose diameter is greater than that of the cord 200, and the bump 230A is of preferably but not limited to a spherical shape. When the locating end 230 enters the groove body serving as the locating portion 130, the bump 230A can be clamped in the groove body, and the cord 200 can extend out of the body 100 through the through groove 130A.

The drive device 300 is disposed in the body 100, is preferably partially exposed from the body 100, and movably releases a restriction on a movement direction of the cord 200 and a restriction on the locating end 230 detaching from the locating portion 130. More specifically, in an embodiment, the drive device 300 includes an operating portion 310 that is exposed from the body 100 for a user to apply force, and a slope surface 320 located at an opposite end of the operating portion 310. The locking module 400 is disposed in the body 100 and is preferably partially exposed from the body 100 to restrict movement of the drive device 300.

Further, in an embodiment, the fixing device 800 further includes a first interference member 510 and a second interference member 520. The first interference member 510 is disposed in the body 100. At least a part is movable into the through portion 120, and is capable of restricting the cord 200 located in the through portion 120 to moving toward a first direction 901. The second interference member 520 is disposed in the body 100, and is capable of restricting the locating end 230 connected to the locating portion 130 to detaching from the locating portion 130.

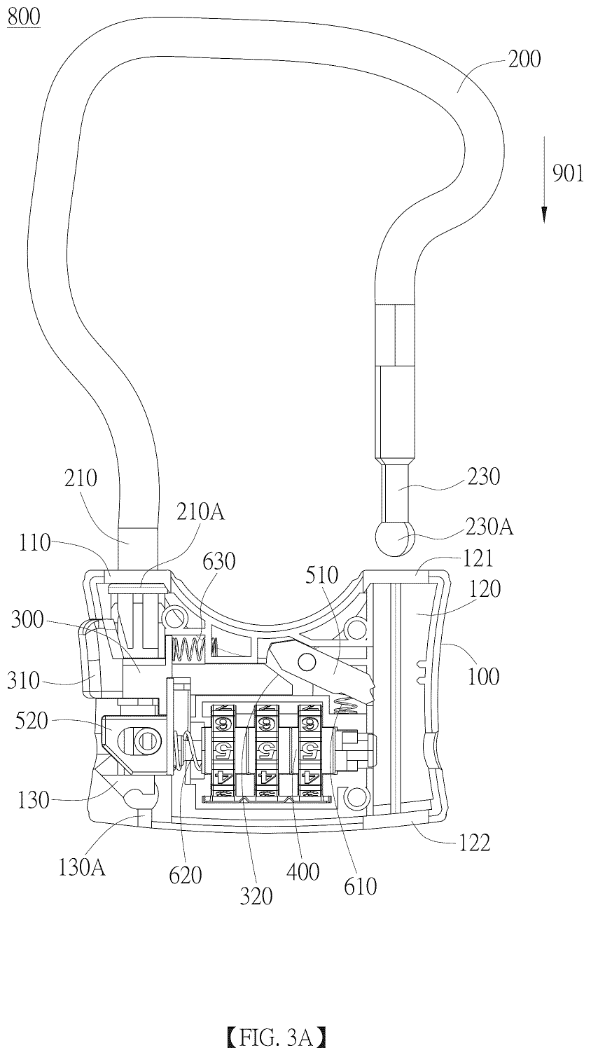

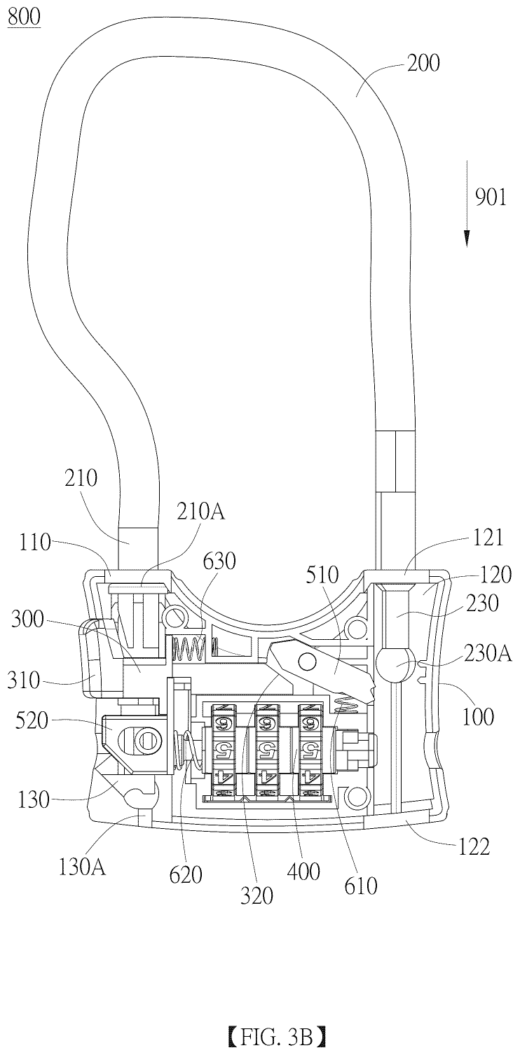

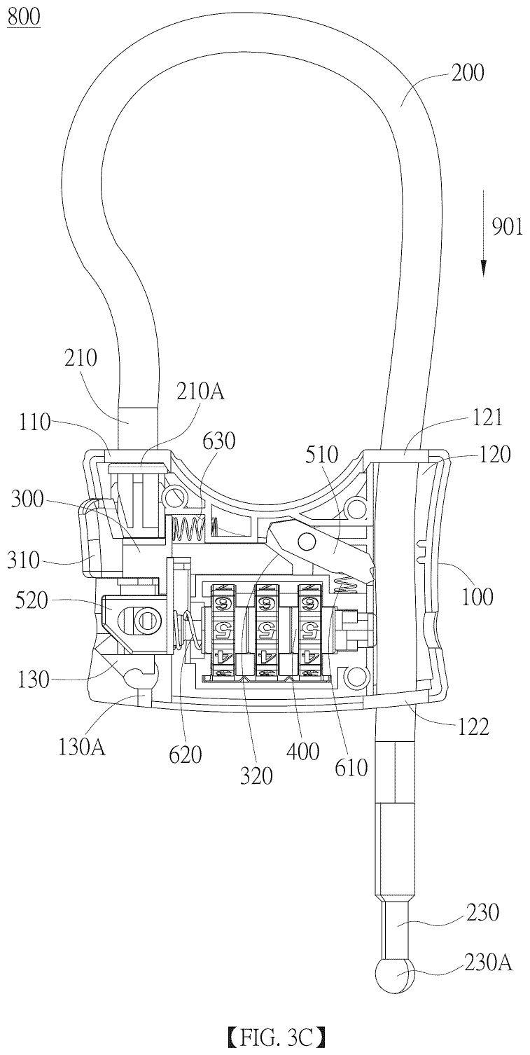

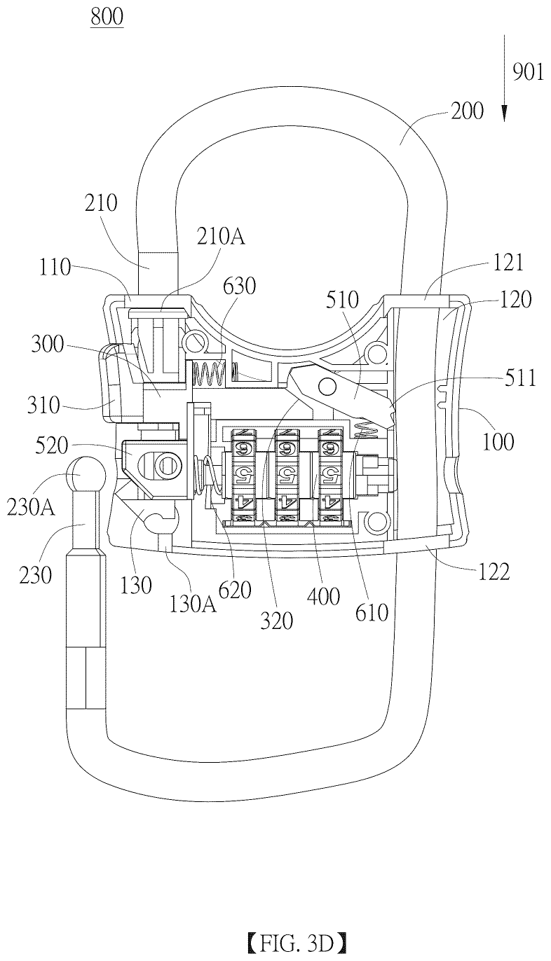

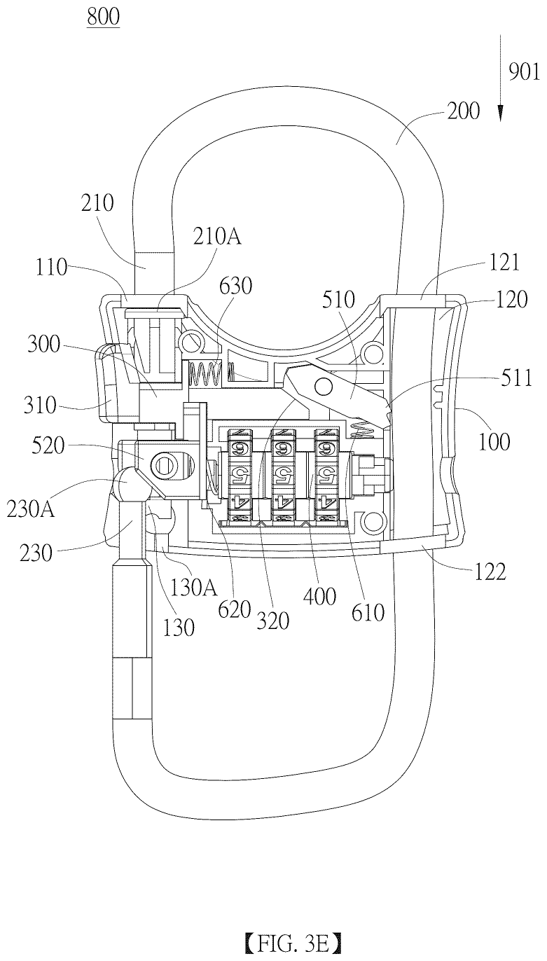

The following describes actuation of the present utility model by using embodiments shown in FIG. 3A to FIG. 5D.

In the embodiment shown in FIG. 3A, the connection end 210 of the cord 200 is fixed to the connection portion 110 of the body 100, and a user can pass the locating end 230 through an object to be fixed, such as a frame or a faucet of a motorcycle or a bicycle. Then, in the embodiment shown in FIG. 3B, the locating end 230 passes through the opening 121 to enter the through portion 120.

In the embodiment shown in FIG. 3C, when the locating end 230 enters the through portion 120 and passes through a location of the first interference member 510, the first interference member 510 can restrict the cord 200 located in the through portion 120 to moving toward the first direction 901. More specifically, the fixing device 800 further includes a first elastic member 610 that provides elastic force to the first interference member 510, so that the first interference member 510 rotates, until one end 511 extends into the through portion 120 to be clamped to the cord 200 located in the through portion 120, restricting the cord 200 to moving toward the first direction 901. That is, the cord 200 can move only toward the first direction 901. Therefore, the user can adjust a range of the first limiting area 710 to match a size of the object to be fixed or to achieve a desired tightness effect.

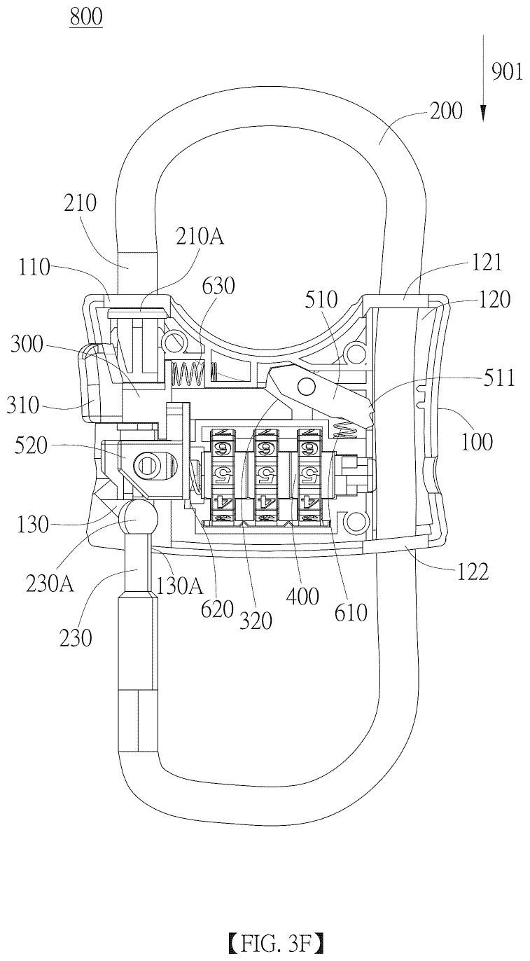

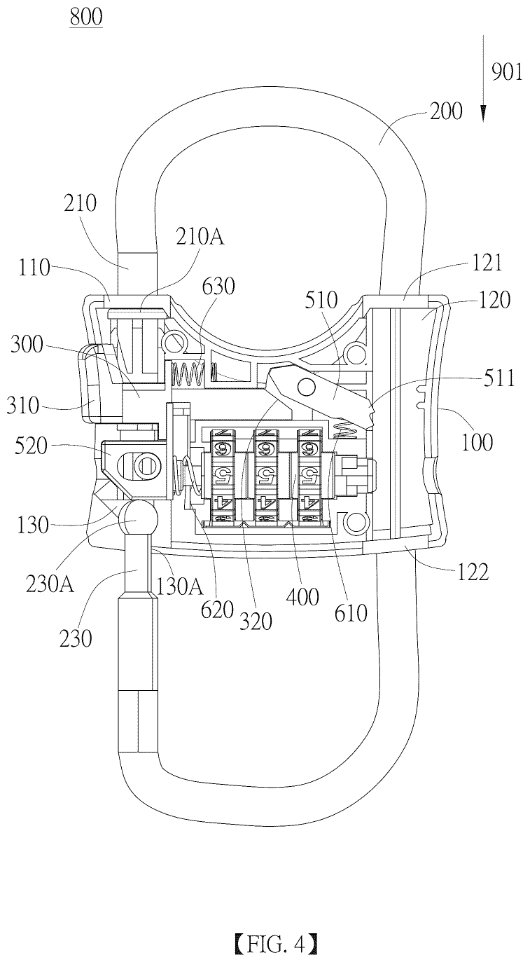

Next, in the embodiment shown in FIG. 3D, the user can further pass the locating end 230 through the object to be locked, for example, a safety helmet. Then, in the embodiment shown in FIG. 3E, when the locking module 400 is in an unlocked state, since the second interference member 520 is movable, the locating end 230 can enter the groove body serving as the locating portion 130. In the embodiment shown in FIG. 3F, the locating end 230 moves until the bump 230A is clamped in the groove body, and the cord 200 can extend out of the body 100 through the through groove 130A. Then, in the embodiment shown in FIG. 4, a second elastic member 620 included in the fixing device 800 provides elastic force to the second interference member 520, so that the second interference member 520 moves to an opening of the groove body serving as the locating portion 130. In this case, the locating end 230 can be blocked from leaving the locating portion 130. If the locking module 400 is further in a locked state, the locking module 400 abuts against the second interference member 520, and the locking module 400 restricts movement of the second interference member 520, thereby locking and fixing an object.

Viewed from a different angle, when the locating end 230 is subject to external force stronger than the elastic force to pass from the outside of the groove body through the opening of the groove body to enter the groove body, the locating end 230 is capable of pushing the second interference member 520 away from the opening of the groove body, and when the locating end 230 enters the groove body, the second interference member 520 can move to the opening of the groove body to restrict the locating end 230 to detachment. The locating end 230 enters through the opening of the groove body located on a side of the body 100, and the cord 200 extends out of the body 100 through the through groove 130A. In other words, when the cord 200 is pulled by external force, the body 100 instead of another component is pulled. Therefore, a probability of damaging the fixing device 800 can be reduced.

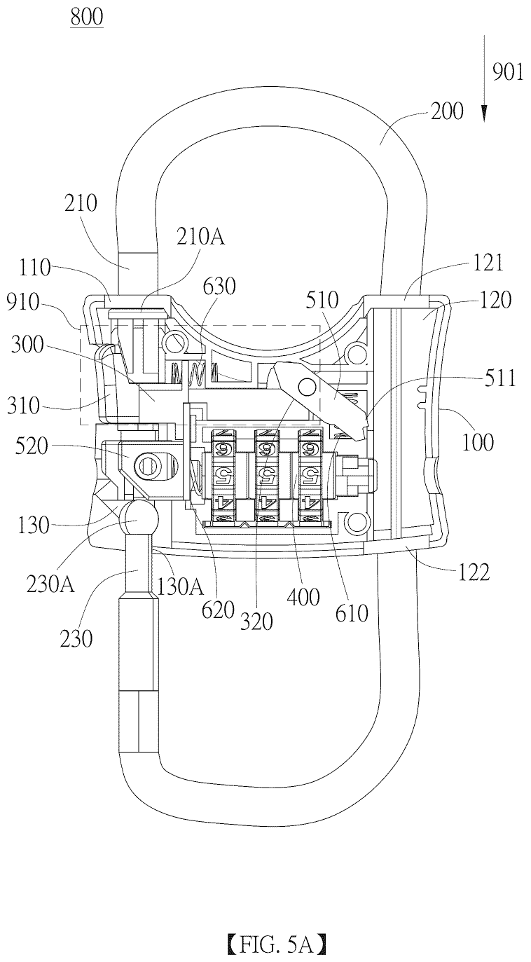

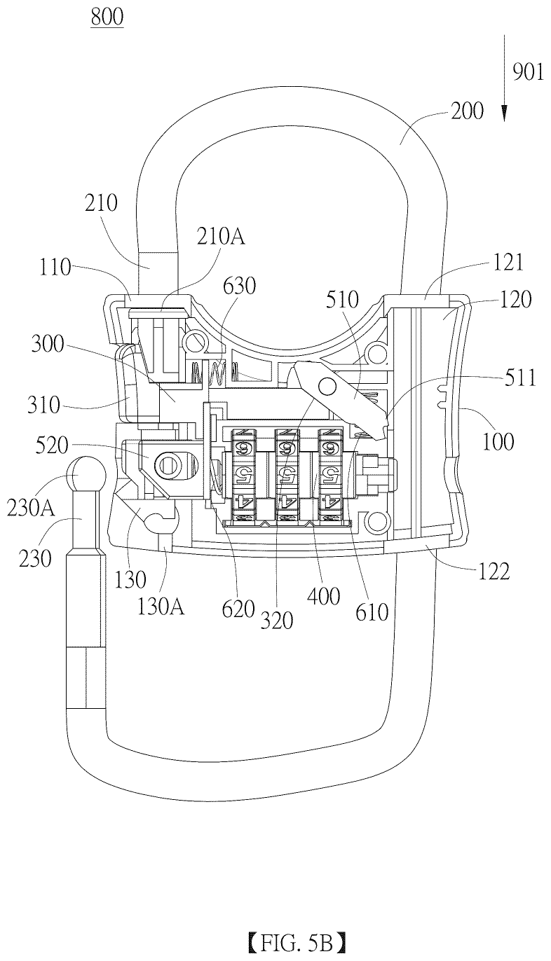

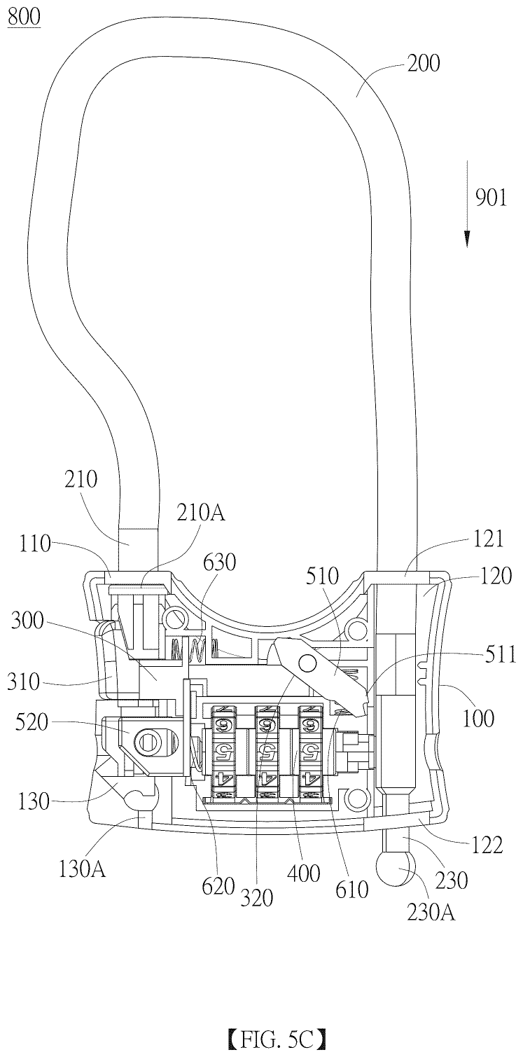

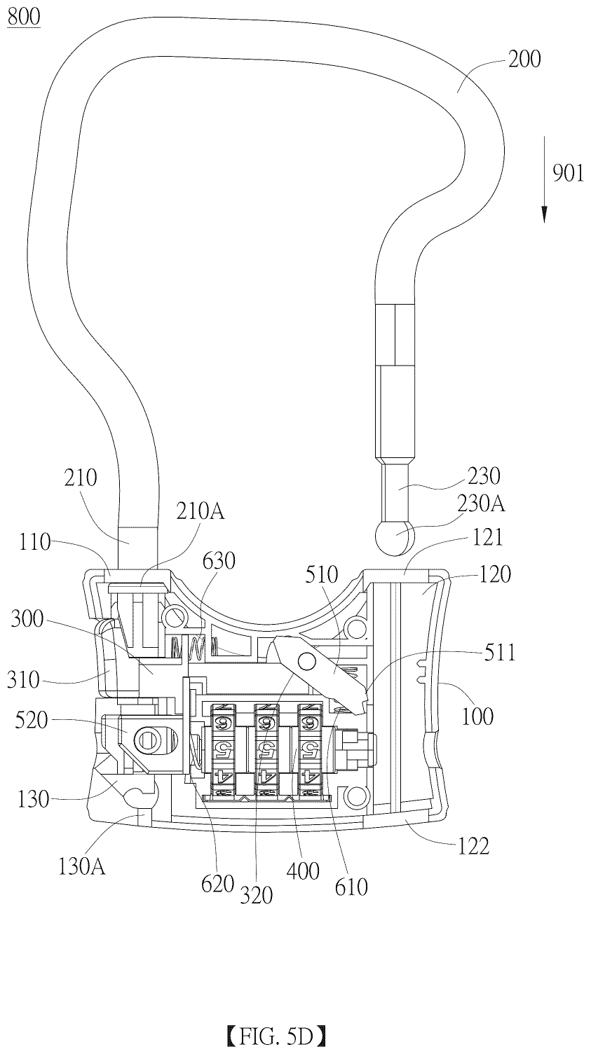

In the embodiment shown in FIG. 5A, when the drive device 300 moves to a releasing location 910, the drive device 300 is capable of abutting against the first interference member 510 and the second interference member 520 separately, to release a restriction of the first interference member 510 on movement of the cord 200, and a restriction of the second interference member 520 on the locating end 230 detaching from the locating portion 130. Further, in this embodiment, the locking module 400 is a combination lock body having a shaft, and the shaft is connected to the second interference member 520. The drive device 300 abuts against the second interference member 520, and when the locking module 400 is in the locked state, the locking module 400 restricts the drive device 300 to moving to the releasing location 910. In contrast, when the locking module 400 is in an unlocked state, the drive device 300 is movable. When the drive device 300 moves to the releasing location 910, the drive device 300 is capable of abutting against the first interference member 510, to overcome the elastic force, so that the first interference member 510 rotates, until an end 511 leaves the through portion 120, to release the restriction of the first interference member 510 on movement of the cord 200. In addition, the drive device 300 may further abut against the second interference member 520, to overcome elastic force to push the second interference member 520 away from the opening of the groove body, so that the locating end 230 can detach from the locating portion 130. Then, in the embodiment shown in FIG. 5B to FIG. 5D, the locating end 230 can detach from the locating portion 130 and the through portion 120 in sequence, thereby releasing the fixing device 800 to locking and fixing an object. The fixing device 800 may include a third elastic member 630 that provides elastic force to the drive device 300, so that the drive device 300 returns to a location after being pressed and displaced.

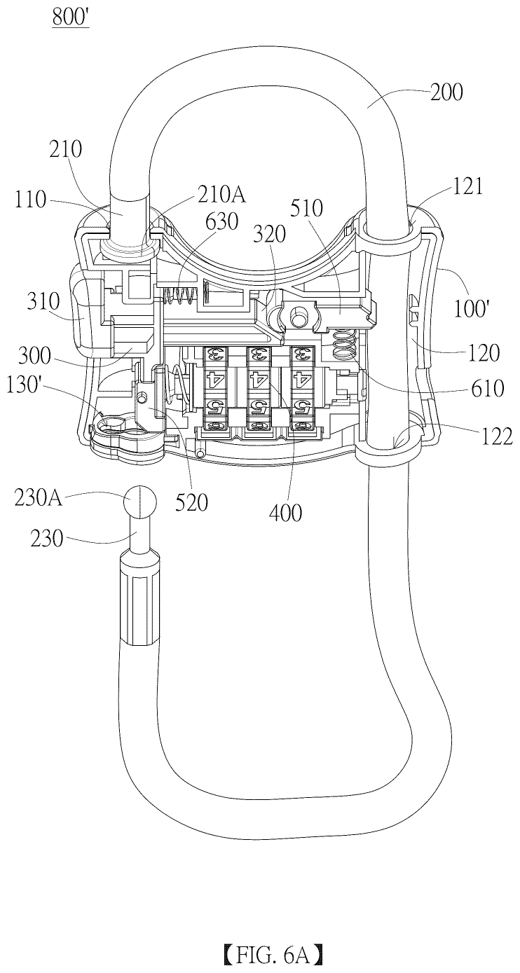

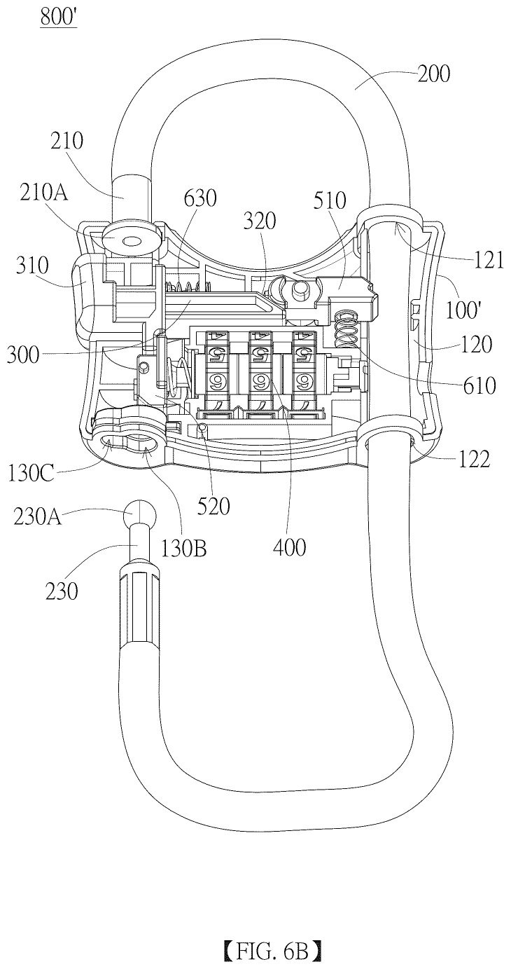

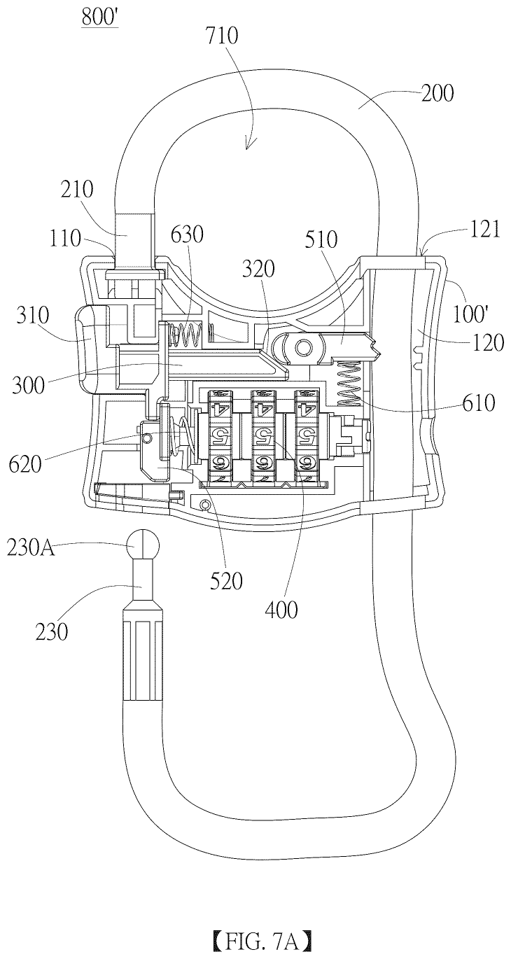

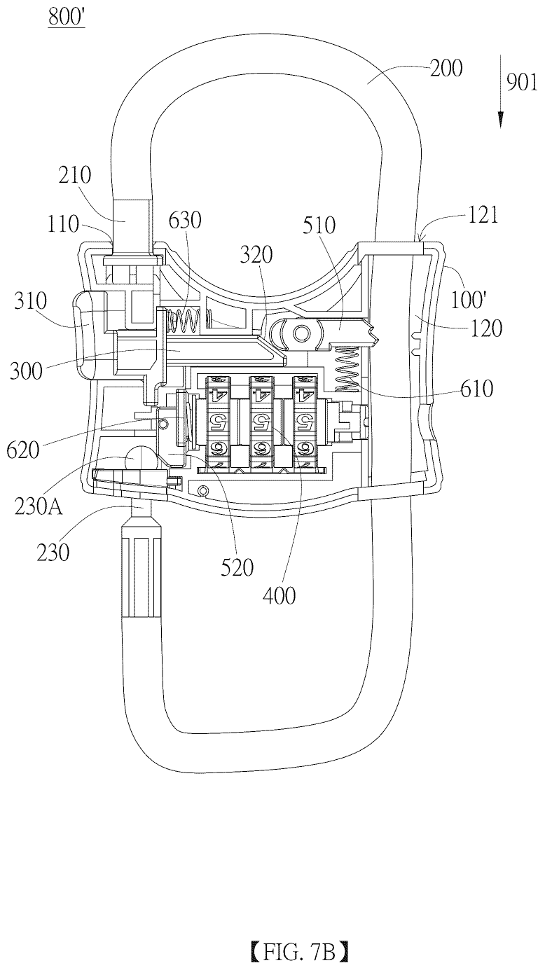

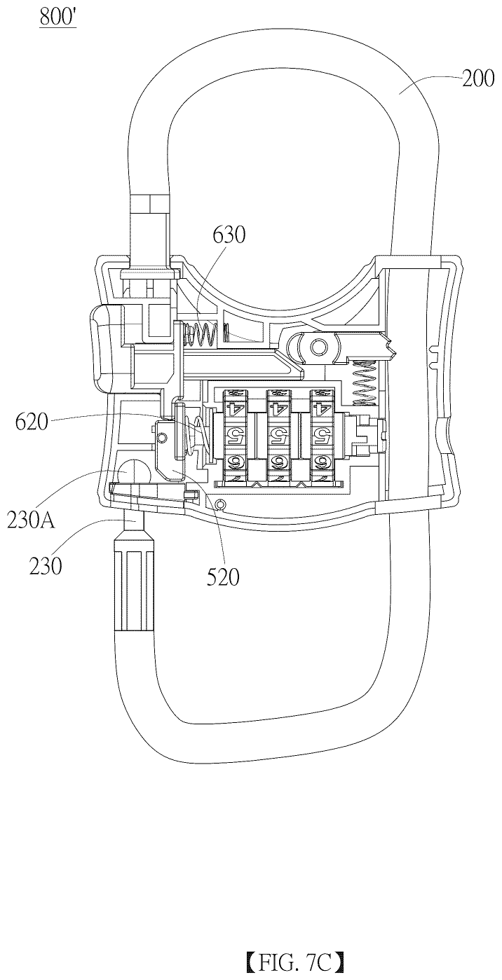

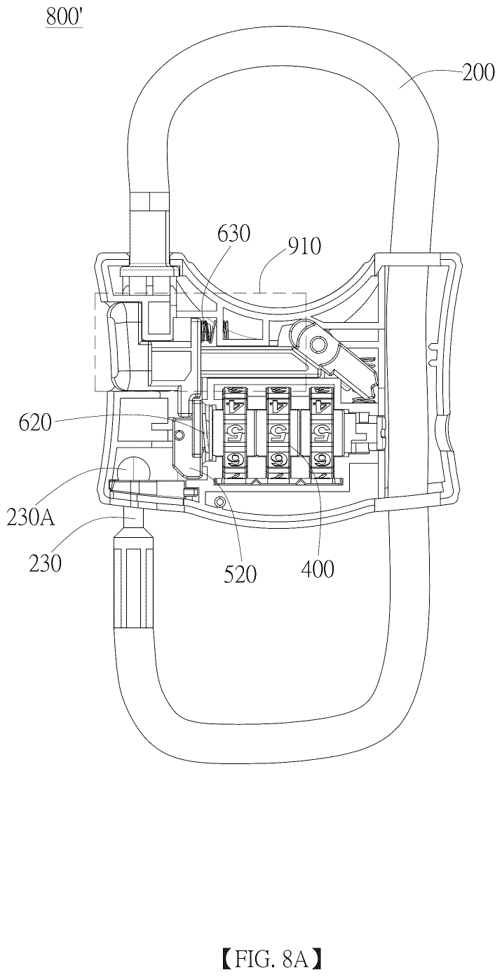

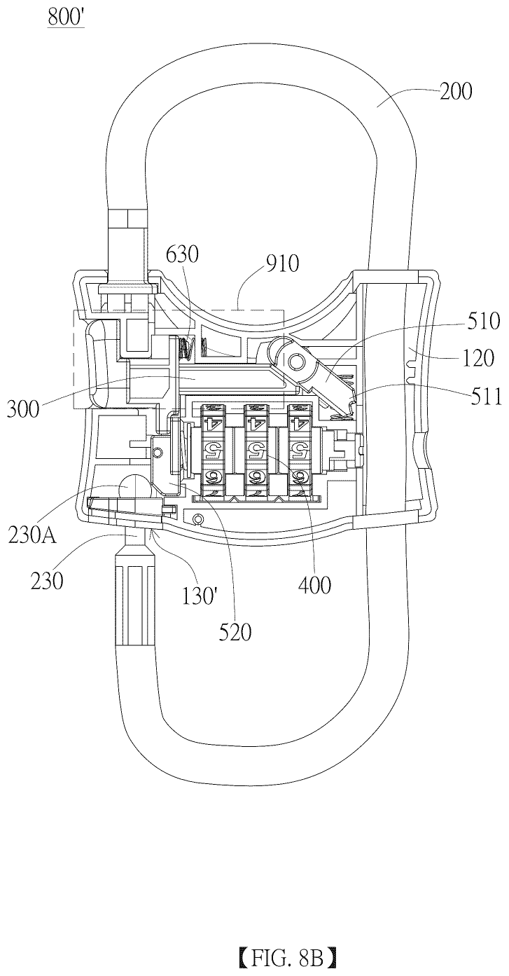

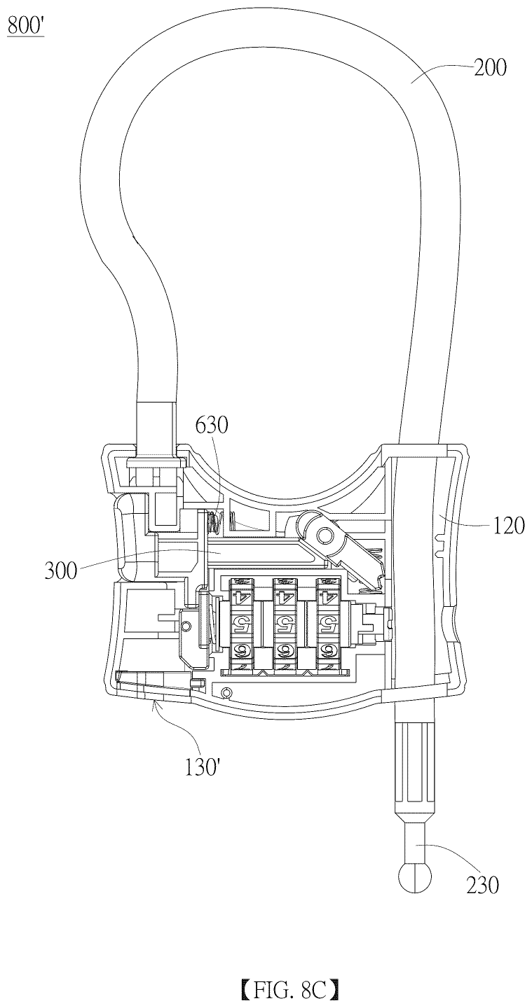

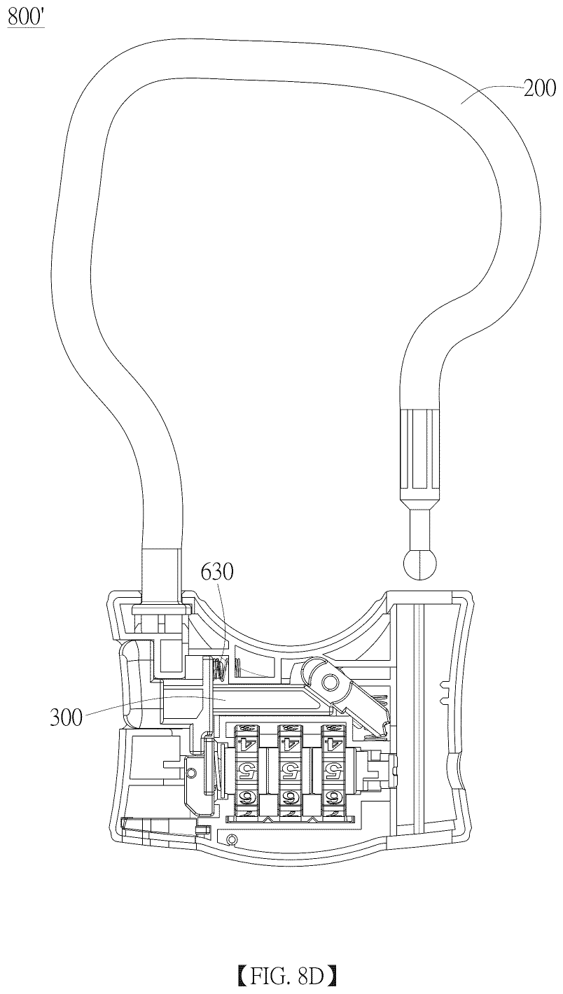

In different embodiments shown in FIG. 6A and FIG. 6B, the locating portion 130′ is disposed on an inner side of a bottom portion of the body 100′, and an opening 130B of the groove body serving as the locating portion 130′ is located at a location other than an opening 122 at the other end of the through portion 120. A through groove 130C in communication with the opening 130B of the groove body is provided at the bottom portion of the groove body. The locating end 230 has a bump 230A with a diameter greater than that of the cord 200. When the locating end 230 enters the groove body serving as the locating portion 130′, the bump 230A can be clamped in the groove body, and the cord 200 can extend out of the body 100′ through the through groove 130C. The following describes actuation of a fixing device 800′ by using embodiments shown in FIG. 7A to FIG. 8D.

In the embodiment shown in FIG. 7A, as described above, a connection end 210 of a cord 200 is fixed to a connection portion 110 of a body 100′, and a user can pass a locating end 230 through an object to be fixed, such as a frame or a faucet of a motorcycle or a bicycle. Then, the locating end 230 passes through an opening 121 to enter a through portion 120. When the locating end 230 enters the through portion 120 and then passes through a location of a first interference member 510, the first interference member 510 can restrict the cord 200 located in the through portion 120 to moving toward a first direction 901. More specifically, the fixing device 800′ further includes a first elastic member 610 that provides elastic force to the first interference member 510, so that the first interference member 510 rotates, until one end 511 extends into the through portion 120 to be clamped to the cord 200 located in the through portion 120, restricting the cord 200 to moving toward the first direction 901. That is, the cord 200 can move only toward the first direction 901. Therefore, the user can adjust a range of a first limiting area 710 to match a size of the object to be fixed or to achieve a desired tightness effect.

Next, the user can further pass the locating end 230 through an object to be locked, for example, a safety helmet. When the locking module 400 is in an unlocked state, since a second interference member 520 is movable, the locating end 230 can enter a groove body serving as a locating portion 130′ (as shown in FIG. 6A) from an opening 130B (as shown in FIG. 6B). In the embodiment shown in FIG. 7B, the locating end 230 moves until a bump 230A is clamped in the groove body, and the cord 200 can extend out of the body 100 through a through groove 130C (as shown in FIG. 6B). Then, in the embodiment shown in FIG. 7C, a second elastic member 620 included in the fixing device 800′ provides elastic force to the second interference member 520, so that the second interference member 520 moves to an opening of the groove body serving as the locating portion 130′. In this case, the locating end 230 can be blocked from leaving the locating portion 130′. If the locking module 400 is further in a locked state, the locking module 400 abuts against the second interference member 520, and the locking module 400 restricts movement of the second interference member 520, thereby locking and fixing an object.

Viewed from a different angle, when the locating end 230 is subject to external force stronger than the elastic force to pass from the outside of the groove body serving as the locating portion 130′ (as shown in FIG. 6A) through an opening 130B (as shown in FIG. 6B) of the groove body to enter the groove body, the locating end 230 is capable of pushing the second interference member 520 away from the opening 130 of the groove body, and when the locating end 230 enters the groove body, the second interference member 520 can move to the opening 130 of the groove body to restrict the locating end 230 to detachment. After the locating end 230 enters the groove body through the opening 130, the cord 200 extends out of the body 100 through the through groove 130C. In other words, when the cord 200 is pulled by external force, the body 100 instead of another component is pulled. Therefore, a probability of damaging the fixing device 800′ can be reduced.

In the embodiment shown in FIG. 8A, when the drive device 300 moves to a releasing location 910, the drive device 300 is capable of abutting against the first interference member 510 and the second interference member 520 separately, to release a restriction of the first interference member 510 on movement of the cord 200, and a restriction of the second interference member 520 on the locating end 230 detaching from the locating portion 130′ (as shown in FIG. 6A). Further, in this embodiment, the locking module 400 is a combination lock body having a shaft, and the shaft is connected to the second interference member 520. The drive device 300 abuts against the second interference member 520, and when the locking module 400 is in the locked state, the locking module 400 restricts the drive device 300 to moving to the releasing location 910. In contrast, when the locking module 400 is in an unlocked state, the drive device 300 is movable. When the drive device 300 moves to the releasing location 910, the drive device 300 is capable of abutting against the first interference member 510, to overcome the elastic force, so that the first interference member 510 rotates 120, until the end 511 leaves the through portion 120, to release the restriction of the first interference member 510 on movement of the cord 200. In addition, the drive device 300 may further abut against the second interference member 520, to overcome elastic force to push the second interference member 520 away from the opening of the groove body serving as the locating portion 130′, so that the locating end 230 can detach from the locating portion 130′. Then, in the embodiments shown in FIG. 8B to FIG. 8D, the locating end 230 can detach from the locating portion 130′ and the through portion 120 in sequence, thereby releasing the fixing device 800′ to locking and fixing an object. The fixing device 800′ may include a third elastic member 630 that provides elastic force to the drive device 300, so that the drive device 300 returns to a location after being pressed and displaced.

Although the foregoing descriptions and drawings have disclosed preferred embodiments of the present utility model, it shall be understood that various additions, many modifications and substitutions may be made to the preferred embodiments of the present utility model without departing from such the spirit and scope of the principles of the present utility model as defined in the appended claims. Those familiar with the present utility model appreciate that the present utility model can be used with many modifications of forms, structures, arrangements, proportions, materials, elements and components. Therefore, the embodiments disclosed herein should be regarded as illustrating the present utility model rather than limiting the present utility model. The scope of the present utility model shall be defined by the appended claims and include their legal equivalents, and shall not be limited to the preceding descriptions.

What is claimed is:

1. A fixing device, comprising:
a body, comprising a connection portion, a through portion, and a locating portion;
a cord, comprising:
a connection end, fixed to the connection portion; and
a locating end, capable of passing through the through portion and detachably connected to the locating portion, so that the cord and the body form two limiting areas;
a drive device, disposed in the body, and movably releasing a restriction on movement of the cord in the through portion and a restriction on the cord detaching from the locating portion; and
a locking module, disposed in the body, and capable of restricting movement of the drive device.

2. The fixing device according to claim 1, further comprising:
a first interference member, disposed in the body, wherein at least a part is movable into the through portion, and is capable of restricting the cord located in the through portion to moving toward a first direction; and
a second interference member, disposed in the body, and capable of restricting the locating end connected to the locating portion to detaching from the locating portion, wherein
when the drive device moves to a releasing location, the drive device is capable of abutting against the first interference member and the second interference member separately, to release a restriction of the first interference member on movement of the cord, and a restriction of the second interference member on the locating end detaching from the locating portion.

3. The fixing device according to claim 2, wherein the locking module abuts against the second interference member, and when the locking module is in a locked state, the locking module restricts movement of the second interference member.

4. The fixing device according to claim 3, wherein the drive device abuts against the second interference member, and when the locking module is in the locked state, the locking module restricts the drive device to moving to the releasing location.

5. The fixing device according to claim 2, wherein the first interference member is a rotating member, and the fixing device further comprises a first elastic member that provides elastic force to the first interference member, so that the first interference member rotates, until one end extends into the through portion to be clamped to the cord located in the through portion, restricting the cord to moving toward the first direction.

6. The fixing device according to claim 5, when the drive device moves to the releasing location, and the drive device is capable of abutting against the first interference member, to overcome the elastic force, so that the first interference member rotates, until the end leaves the through portion, to release the restriction of the first interference member on movement of the cord.

7. The fixing device according to claim 2, wherein the locating portion is a groove body, and the fixing device further comprises a second elastic member that provides elastic force to the second interference member, so that the second interference member can move to an opening of the groove body.

8. The fixing device according to claim 7, wherein when the locating end is subject to external force stronger than the elastic force to pass from the outside of the groove body through an opening of the groove body to enter the groove body, the locating end is capable of pushing the second interference member away from the opening of the groove body, and when the locating end enters the groove body, the second interference member is capable of moving to the opening of the groove body, to restrict the locating end to detachment.

9. The fixing device according to claim 7, wherein an opening at one end of the through portion and the connection portion are disposed at a top portion of the body, an opening at the other end of the through portion is disposed at a bottom portion of the body, the locating portion is disposed on a side of the body, a through groove is disposed at a bottom portion of the groove body, the locating end has a bump with a diameter greater than a diameter of the cord, when the locating end enters the groove body, the bump is capable of being clamped in the groove body, and the cord is capable of extending out of the body through the through groove.

10. The fixing device according to claim 7, wherein an opening at one end of the through portion and the connection portion are disposed at a top portion of the body, an opening at the other end of the through portion is disposed at a bottom portion of the body, the locating portion is disposed on an inner side of the bottom portion of the body, an opening of the groove body is located at a location other than the opening at the other end of the through portion, a through groove in communication with the opening of the groove body is disposed at a bottom portion of the groove body, the locating end has a bump with a diameter greater than a diameter of the cord, when the locating end enters the groove body, the bump is capable of being clamped in the groove body, and the cord is capable of extending out of the body through the through groove.

11. The fixing device according to claim 2, wherein the locking module is a combination lock body having a shaft, and the shaft is connected to the second interference member.
